(19) United States
(12) Patent Application Publication
(10) Pub. No.: US 2003/0061988 A1
(43) Pub. Date: Apr. 3, 2003

(54) Disc painting machine for painting various discs

(76) Inventor: Jen Show Hsieh, Chong Ho City (TW)

Correspondence Address: Jen Show HSIEH, P.O. Box 10-69, Chong Ho, Taichung, 235, TW

(21) Appl. No.: 09/968,136

(22) Filed: Sep. 28, 2001

(51) Int. Cl. B05C 11/00

(52) U.S. Cl. 118/712

(57) ABSTRACT

A disc painting or treating machine includes one or more holder devices, and a device for moving non-circular discs onto the holder devices. The holder devices each includes a non-circular opening for receiving and for correctly positioning the non-circular disc on the holder device, and for allowing the non-circular disc to be correctly printed or painted or treated by a treating device. A positioning device is disposed beside the holder devices and includes a non-circular surface for engaging with and for correctly positioning the non-circular discs.

### BACKGROUND OF THE INVENTION

1. Field of the Invention

The present invention relates to a disc printing or painting machine, and more particularly to a disc printing or painting machine for painting or for printing or for applying patterns or information onto various kinds of discs.

2. Description of the Prior Art

Typical disc printing or painting machines are designed and provided for painting or for printing or for applying patterns or information onto circular discs, such as the magnetic discs, the floppy discs, the optical discs, the compact discs, and the like. However, various kinds of non-circular discs have been developed recently and may not be suitably printed or painted by the typical disc printing or painting machines. The typical disc printing or painting machines that are provided for printing or painting the typical circular discs having no positioning or calibrating or aligning devices for calibrating and for correctly positioning the discs at the correct positions for being treated by the typical disc printing or painting machine.

The present invention has arisen to mitigate and/or obviate the afore-described disadvantages of the conventional disc printing or painting machines.

### SUMMARY OF THE INVENTION

The primary objective of the present invention is to provide a disc printing or painting machine for painting or for printing or for applying patterns or information onto various kinds of discs, particularly the square or the rectangular discs.

In accordance with one aspect of the invention, there is provided a disc painting machine comprising a machine body, at least one holder device disposed on the machine body, a non-circular disc, and means for moving the non-circular disc onto the holder device. The holder device includes a non-circular opening formed therein for receiving the non-circular disc and for correctly positioning the non-circular disc on the holder device, and for allowing the non-circular disc to be correctly printed or painted or treated by a printing or painting or treating device.

The holder device includes a mold board having the non-circular opening formed therein for receiving the non-circular disc, and includes a base board, the mold board is disposed on the base board.

The holder device includes an upper board selectively secured on the base board when the mold board is disengaged from the base board, the upper board includes a circular opening formed therein for receiving circular discs.

A device is further provided for calibrating the non-circular disc before the non-circular disc is disposed on the holder device and includes a positioning device disposed beside the holder device for engaging with and for correctly positioning the non-circular disc relative to the holder device before the non-circular disc is disposed on the holder device.

The positioning device includes a non-circular surface formed therein for engaging with and for correctly positioning the non-circular disc relative to the holder device.

The machine body includes a platform disposed thereon, the platform includes an outer peripheral portion for supporting the holder device thereon.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a disc printing or painting machine in accordance with the present invention;

FIG. 2 is a perspective view illustrating a holder device for supporting the circular discs;

FIG. 3 is a perspective view illustrating an aligning or positioning or calibrating device for positioning the non-circular discs to the correct positions for painting purposes;

FIG. 4 is a perspective view illustrating another holder device for supporting the non-circular discs; and

FIG. 5 is a bottom perspective view illustrating a member or a part of the holder device as shown in FIG. 4, for supporting the non-circular discs.

### DETAILED DESCRIPTION OF THE PREFERRED EMBODIMENT

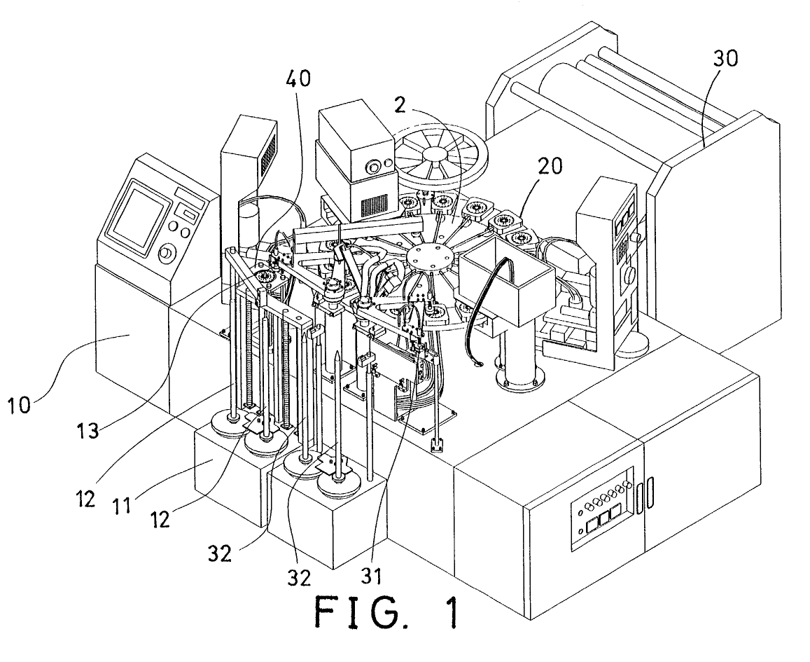

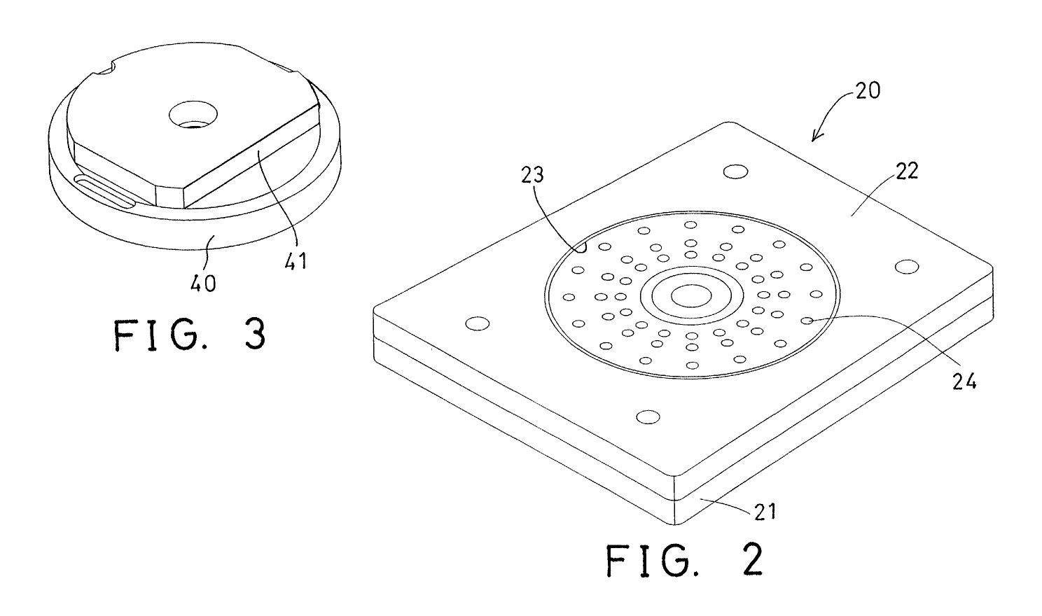

Referring to the drawings, and initially to FIGS. 1 and 2, a disc printing or painting machine in accordance with the present invention comprises a machine body 10, a table 11 for supporting the discs to be printed or painted or treated, such as the magnetic discs, the floppy discs, the optical discs, the compact discs, and the like. One or more rods 12 are disposed and extended upward from the table 11. The discs normally include a hole formed therein for receiving the rods 12 and for allowing the discs to be superposed and disposed and stacked and collected on the rods 12 respectively.

A platform 2 is disposed on the machine body 10 and includes a number of holder devices 20 disposed on the peripheral portion thereof for receiving and supporting the discs to be printed or painted or treated by the disc printing or painting machine. A printing or painting device 30 may be used for A disc drawing or taking device 13 may be used for taking or fetching the discs stacked on the rods 12 and may move the discs to the holder devices 20. A printing or painting or treating device 30 may be used or provided for printing or painting or treating the discs that are supported and positioned on the holder devices 20. The platform 2 may be rotated relative to the machine body 10 or the treating device 30 for moving the holder devices 20 into or through the printing or painting or treating device 30 step by step or one by one.

As shown in FIG. 2, the holder devices 20 each includes a base board 21, and a mold or upper board 22 disposed or secured on the base board 21, and each includes a circular recess 23 formed or provided on top thereof, such as formed in the upper portion of the upper board 22 for receiving circular discs thereon, and each includes a number of holes 24 formed therein and coupled to the vacuum source or the like for drawing or sucking or firmly securing the circular discs on the holder devices 20.

After being printed or painted or treated by the printing or painting or treating device 30, the machine body 10 further includes another disc drawing or taking device 31 for taking or fetching the discs that are supported on the holder devices 20 and that have been printed or painted or treated by the printing or painting or treating device 30, and for moving the discs to the other posts 32 for allowing the treated discs to be stacked and collected on the posts 32. The above-described disc printing or painting machine is typical and will not be described in further details.

Referring next to FIG. 3, and again to FIG. 1, the disc printing or painting machine further includes an aligning or calibrating or positioning device 40 disposed on the machine body 10 and disposed beside the platform 2 and having a calibrating surface 41, such as a flat surface or a non-circular curved surface or the like formed therein, for engaging with the side surfaces of the non-circular discs, such as the square or rectangular discs, and for positioning the non-circular discs to the correct positions, and for allowing the non-circular discs to be correctly and precisely printed or painted or treated.

In operation, the disc drawing or taking device 13 may move the non-circular discs to engage with the calibrating surface 41 of the positioning device 40 for correctly aligning or calibrating or positioning the discs relative to the machine body 10 and the platform 2 and the holder devices 20, and for allowing the discs to be correctly disposed on and supported on the holder devices 20.

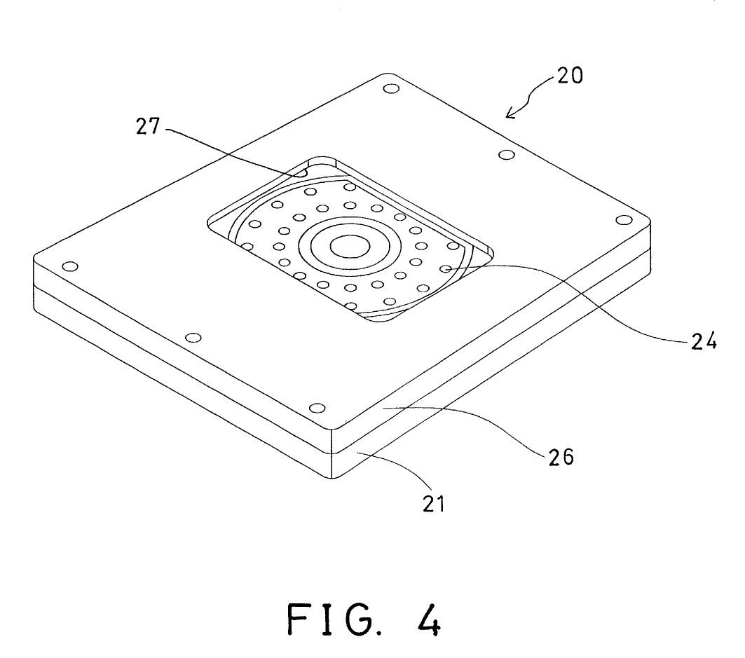

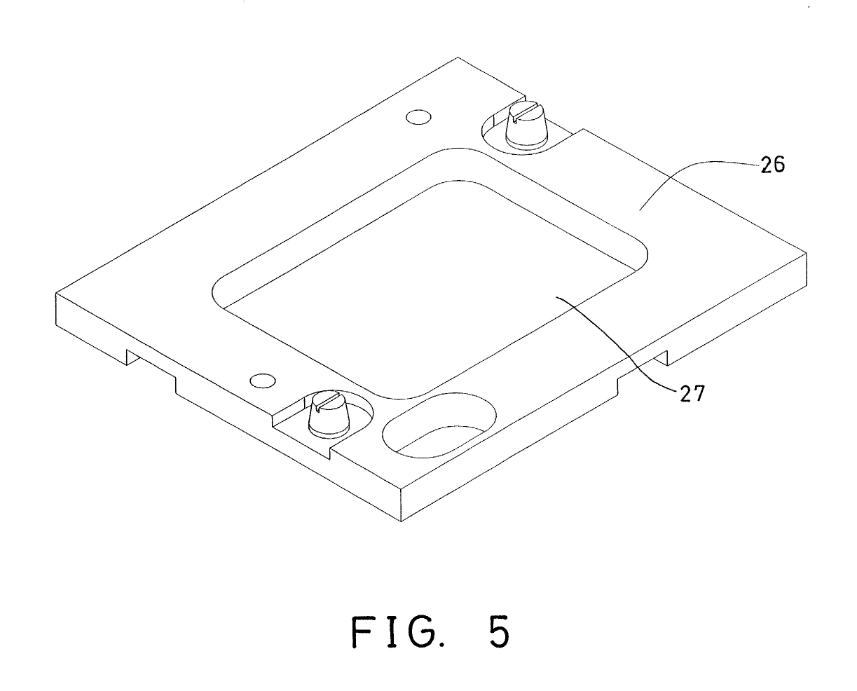

Referring next to FIGS. 4 and 5, the holder devices 20 may each includes a mold or upper board 26 selectively or changeably secured on the base board 21, and having a non-circular opening 27, such as a square or a rectangular opening 27 formed therein for correctly and suitably receiving the non-circular discs on the holder devices 20, and for allowing the non-circular discs to be suitably printed or painted or treated by the printing or painting or treating device 30.

Accordingly, the disc printing or painting machine in accordance with the present invention may be used for painting or for printing or for applying patterns or information onto various kinds of discs, particularly the square or the rectangular discs.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A disc painting machine comprising:
a machine body,
at least one holder device disposed on said machine body,
a non-circular disc, and
means for moving said non-circular disc onto said at least one holder device,
said at least one holder device including a non-circular opening formed therein for receiving said non-circular disc and for correctly positioning said non-circular disc on said at least one holder device.

2. The disc painting machine according to claim 1, wherein said at least one holder device includes a mold board having said non-circular opening formed therein for receiving said non-circular disc.

3. The disc painting machine according to claim 2, wherein said at least one holder device includes a base board, said mold board is disposed on said base board.

4. The disc painting machine according to claim 3, wherein said at least one holder device includes an upper board selectively secured on said base board when said mold board is disengaged from said base board, said upper board includes a circular opening formed therein for receiving circular discs.

5. The disc painting machine according to claim 1 further comprising means for calibrating said non-circular disc before said non-circular disc is disposed on said at least one holder device.

6. The disc painting machine according to claim 5, wherein said calibrating means includes a positioning device disposed beside said at least one holder device for engaging with and for correctly positioning said non-circular disc relative to said at least one holder device before said non-circular disc is disposed on said at least one holder device.

7. The disc painting machine according to claim 6, wherein said positioning device includes a non-circular surface formed therein for engaging with and for correctly positioning said non-circular disc relative to said at least one holder device.

8. The disc painting machine according to claim 1, wherein said machine body includes a platform disposed thereon, said platform includes an outer peripheral portion for supporting said at least one holder device thereon.
